(19) United States
(12) Patent Application Publication
(10) Pub. No.: US 2026/0016296 A1
(43) Pub. Date: Jan. 15, 2026

(54) DETECTION SYSTEM FOR WORK SITE AND DETECTION METHOD FOR WORK SITE

(71) Applicant: KOMATSU LTD., Tokyo (JP)

(72) Inventors: Masataka Ozaki, Tokyo (JP); Toshihide Mineushiro, Tokyo (JP); Toyohisa Matsuda, Tokyo (JP)

(73) Assignee: KOMATSU LTD., Tokyo (JP)

(21) Appl. No.: 18/994,858

(22) PCT Filed: Sep. 7, 2023
(86) PCT No.: PCT/JP2023/032613

§ 371 Date: Jan. 15, 2025

(30) Foreign Application Priority Data
Sep. 30, 2022 (JP) 2022-158986

(51) Int. Cl. G01C 15/00; E02F 9/26; G01S 17/42; G01S 17/88

(52) U.S. Cl. CPC G01C 15/008; E02F 9/261; G01S 17/42; G01S 17/88

(57) ABSTRACT

A detection system for a work site includes: a three-dimensional data acquisition unit that acquires three-dimensional data of the work site where a work machine operates; a current terrain data storage unit that stores current terrain data created on the basis of the three-dimensional data and time in association with each other; and a determination unit that determines whether or not there is a cliff at the work site on the basis of storage data stored in the current terrain data storage unit.

### FIELD

The present disclosure relates to a detection system for a work site and a detection method for a work site.

### BACKGROUND

In the technical field related to work machines, work vehicles such as those disclosed in Patent Literature 1 are known.

### CITATION LIST

### Patent Literature

Patent Literature 1: JP 2019-214868 A

### SUMMARY

### Technical Problem

In a work site such as a mine, cliffs may be present. If the work machine continues to work without recognizing the presence of cliffs, productivity at the work site may be reduced.

An object of the present disclosure is to recognize cliffs present at work sites.

### Solution to Problem

In order to achieve an aspect of the present invention, a detection system for a work site, the detection system comprises: a three-dimensional data acquisition unit that acquires three-dimensional data of the work site where a work machine operates; a current terrain data storage unit that stores current terrain data created on a basis of the three-dimensional data and time in association with each other; and a determination unit that determines whether or not there is a cliff at the work site on a basis of storage data stored in the current terrain data storage unit.

### Advantageous Effects of Invention

According to the present disclosure, it is possible to recognize cliffs present at work sites.

### BRIEF DESCRIPTION OF DRAWINGS

FIG. 1 is a diagram schematically illustrating a management system of a work site according to an embodiment.

FIG. 2 is a side view schematically illustrating a work machine according to the embodiment.

FIG. 3 is a plan view schematically illustrating a three-dimensional sensor and an obstacle sensor according to the embodiment.

FIG. 4 is a diagram schematically illustrating an example of an operation of the work machine according to the embodiment.

FIG. 5 is a block diagram illustrating a detection system for the work machine according to the embodiment.

FIG. 6 is a diagram for explaining storage data stored in a current terrain data storage unit according to the embodiment.

FIG. 7 is a diagram for explaining a method for determining the presence or absence of a cliff by a determination unit according to the embodiment.

FIG. 8 is a diagram for explaining a method for determining the presence or absence of a cliff by a determination unit according to the embodiment.

FIG. 9 is a diagram for explaining a method for determining the presence or absence of a cliff by a determination unit according to the embodiment.

FIG. 10 is a diagram for explaining a method for determining the presence or absence of a cliff by a determination unit according to the embodiment.

FIG. 11 is a flowchart illustrating a detection method for a work site according to the embodiment.

FIG. 12 is a block diagram illustrating a computer system according to the embodiment.

### DESCRIPTION OF EMBODIMENTS

Hereinafter, embodiments according to the present disclosure will be described with reference to the drawings, but the present disclosure is not limited to the embodiments. The components of the embodiments described below can be appropriately combined. In addition, some components may not be used.

[Management System]

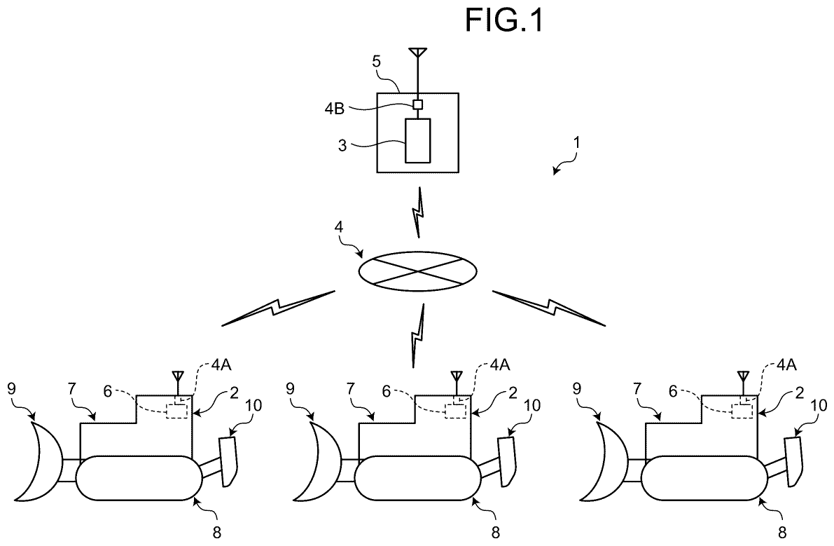

FIG. 1 is a diagram schematically illustrating a management system 1 of a work site according to an embodiment. In the embodiment, the work site is a mine. The mine refers to a place or business site where minerals are mined. Examples of the mine include a metal mine for mining metal, a non-metal mine for mining limestone, and a coal mine for mining coal. A plurality of work machines 2 operates at a work site. In the embodiment, the work machine 2 is a bulldozer. The work machine 2 performs predetermined work at a work site. Examples of the work performed by the work machine 2 include excavating work, pushing work, and leveling work.

The management system 1 includes a management device 3 and a communication system 4. The management device 3 includes a computer system. The management device 3 is disposed outside the work machine 2. The management device 3 is installed in a control facility 5 of the work site. The management device 3 manages the work site and the work machine 2. Administrators are present in the control facility 5. Examples of the communication system 4 include the internet, a mobile phone communication network, a satellite communication network, and a local area network (LAN). Wi-Fi (registered trademark), which is one standard of wireless LAN, is exemplified as the local area network.

The work machine 2 includes a control device 6 and a wireless communication device 4A. The control device 6 includes a computer system. The wireless communication device 4A is connected to the control device 6. The communication system 4 includes the wireless communication device 4A connected to the control device 6 and a wireless communication device 4B connected to the management device 3. The management device 3 and the control device 6 of the work machine 2 wirelessly communicate with each other via the communication system 4.

### [Work Machine]

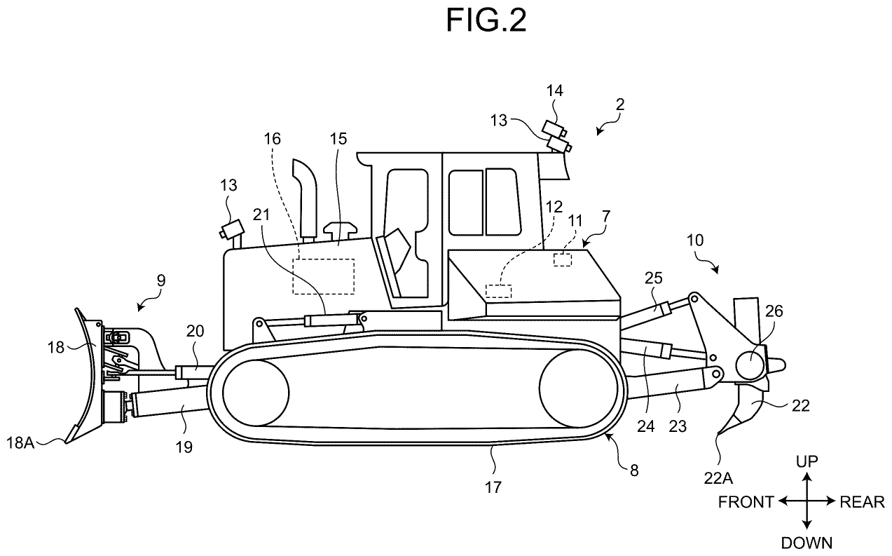

FIG. 2 is a side view schematically illustrating the work machine 2 according to the embodiment. As illustrated in FIG. 2, the work machine 2 includes a vehicle body 7, a traveling device 8, an excavation working equipment 9, a ripper working equipment 10, a position sensor 11, an inclination sensor 12, a three-dimensional sensor 13, and an obstacle sensor 14. The vehicle body 7 includes an engine compartment 15. An engine 16 is housed in the engine compartment 15. The engine 16 is a drive source of the work machine 2. The traveling device 8 travels while supporting the vehicle body 7. The traveling device 8 includes a pair of crawler belts 17. As the crawler belt 17 rotates, the work machine 2 travels.

The excavation working equipment 9 performs excavating work, pushing work, or leveling work of a work target. The excavation working equipment 9 is attached to the vehicle body 7. At least a part of the excavation working equipment 9 is disposed in front of the vehicle body 7. The excavation working equipment 9 includes an excavation blade 18, a lift frame 19, a tilt cylinder 20, and a lift cylinder 21.

The excavation blade 18 is disposed in front of the vehicle body 7. The excavation blade 18 includes a cutting edge 18A. The lift frame 19 supports the excavation blade 18. One end portion of the lift frame 19 is connected to the back surface of the excavation blade 18 via a pivot mechanism. The other end portion of the lift frame 19 is connected to the vehicle body 7 via a pivot mechanism. Note that the other end portion of the lift frame 19 may be connected to the traveling device 8 via a pivot mechanism.

Each of tilt cylinder 20 and lift cylinder 21 operates the excavation blade 18. The tilt cylinder 20 is driven to tilt the excavation blade 18. The lift cylinder 21 is driven to move the excavation blade 18 up and down. One end portion of the tilt cylinder 20 is connected to the back surface of the excavation blade 18 via a pivot mechanism. The other end portion of the tilt cylinder 20 is connected to the upper surface of the lift frame 19. As the tilt cylinder 20 extends and contracts, the tilt angle of the excavation blade 18 changes. One end portion of the lift cylinder 21 is connected to the lift frame 19 via a pivot mechanism. The other end portion of the lift cylinder 21 is connected to the vehicle body 7 via a pivot mechanism. As the lift cylinder 21 expands and contracts, the excavation blade 18 moves in the vertical direction.

The ripper working equipment 10 performs ripping work including cutting or crushing of the work target. The ripper working equipment 10 is attached to the vehicle body 7. At least a part of the ripper working equipment 10 is disposed behind the vehicle body 7. The ripper working equipment 10 includes a shank 22, a ripper arm 23, a tilt cylinder 24, a lift cylinder 25, and a beam 26. The shank 22 is disposed behind the vehicle body 7. The shank 22 has a ripper point 22A. The ripper point 22A is provided at the tip of the shank 22. The ripper arm 23 supports the shank 22. The ripper arm 23 connects the vehicle body 7 and the shank 22. One end portion of the ripper arm 23 is connected to the rear portion of the vehicle body 7 via a pivot mechanism. The other end portion of the ripper arm 23 is connected to the beam 26. The beam 26 is rotatably connected to the ripper arm 23. The shank 22 is connected to the ripper arm 23 via the beam 26.

Each of the tilt cylinder 24 and the lift cylinder 25 operates the shank 22. Each of the tilt cylinder 24 and the lift cylinder 25 is connected to the vehicle body 7. The tilt cylinder 24 is driven to tilt the shank 22. The lift cylinder 25 is driven to move the shank 22 up and down. One end portion of the tilt cylinder 24 is connected to the beam 26 via a pivot mechanism. The other end portion of the tilt cylinder 24 is connected to the rear portion of the vehicle body 7. As the tilt cylinder 24 extends and contracts, the tilt angle of the shank 22 changes. The tilt cylinder 24 moves the shank 22 in the front-rear direction. One end portion of the lift cylinder is connected to the beam 26 via a pivot mechanism. The other end portion of the lift cylinder 25 is connected to the rear portion of the vehicle body 7. As the lift cylinder 25 expands and contracts, the shank 22 moves in the vertical direction. The lift cylinder 25 moves the shank 22 in the vertical direction.

The ripper working equipment 10 pierces the ripper point 22A into the work target. As the traveling device 8 travels in a state where the ripper point 22A is pierced into the work target, the work target is cut or crushed. While the traveling device 8 is traveling, the shank 22 may be moved in the vertical direction and the front-rear direction.

The position sensor 11 detects the position of the work machine 2. The position of the work machine 2 is detected using a global navigation satellite system (GNSS). The global navigation satellite system includes a global positioning system (GPS). The global navigation satellite system detects a position in a global coordinate system defined by coordinate data of latitude, longitude, and altitude. The global coordinate system refers to a coordinate system fixed to the earth. The position sensor 11 includes a GNSS receiver. The position sensor 11 detects the position of the work machine 2 in the global coordinate system. The position sensor 11 is disposed on the vehicle body 7.

The inclination sensor 12 detects the inclination of the vehicle body 7. The inclination sensor 12 detects an inclination angle of the vehicle body 7 with respect to a horizontal plane. The inclination sensor 12 includes an inertial measurement unit (IMU). The inclination sensor 12 is disposed on the vehicle body 7.

The three-dimensional sensor 13 detects a three-dimensional shape of a detection target. The three-dimensional sensor 13 detects the three-dimensional shape of the detection target in a non-contact manner with the detection target. The detection target of the three-dimensional sensor 13 includes a work site. The three-dimensional sensor 13 detects a three-dimensional shape of the work site. The three-dimensional shape of the work site includes the terrain of the work site. The three-dimensional sensor 13 detects the distance to the surface of the detection target. The three-dimensional sensor 13 detects the three-dimensional shape of the surface of the detection target by detecting the relative distance to each of the plurality of detection points on the surface of the detection target. The three-dimensional data indicating the three-dimensional shape of the detection target includes point cloud data including a plurality of detection points. The three-dimensional data includes a relative distance and a relative position between the three-dimensional sensor 13 and each of the plurality of detection points defined in the detection target. The three-dimensional data includes height data of each of the plurality of detection points. As the three-dimensional sensor 13, a laser sensor (light detection and ranging (LIDAR)) that detects a detection target by emitting laser light is exemplified. Note that the three-dimensional sensor 13 may be a three-dimensional camera such as a stereo camera. The three-dimensional sensor 13 is disposed on the vehicle body 7.

The obstacle sensor 14 detects an obstacle of the work machine 2 present at the work site. The obstacle sensor 14 detects an obstacle in a non-contact manner with the obstacle. As the obstacle sensor 14, a radar sensor (radio detection and ranging (RADAR)) that detects an obstacle by emitting radio waves is exemplified. Note that obstacle sensor 14 may be an infrared sensor that detects an obstacle by emitting infrared light. The obstacle sensor 14 is disposed on the vehicle body 7.

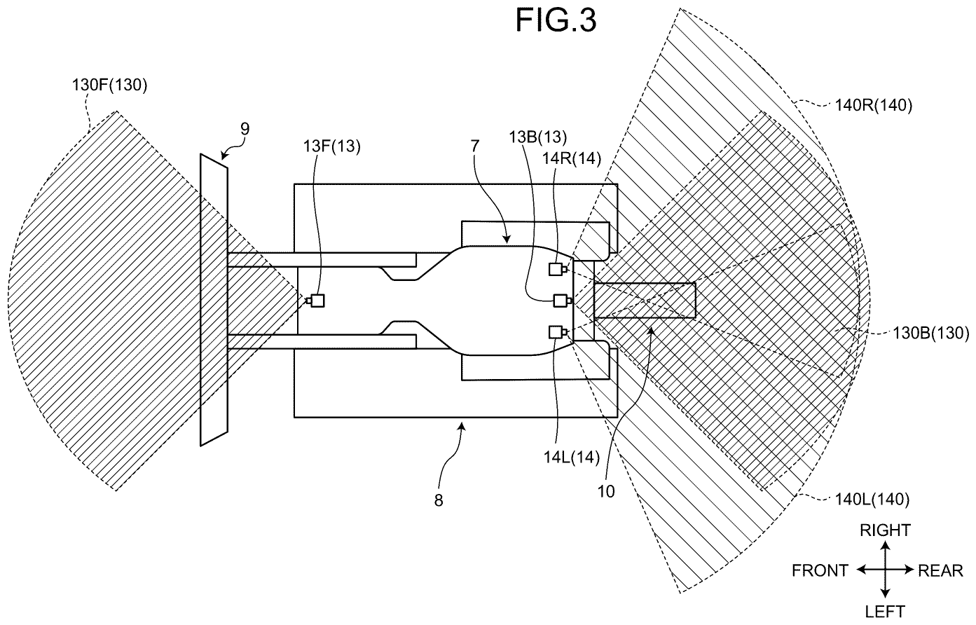

FIG. 3 is a plan view schematically illustrating the three-dimensional sensor 13 and the obstacle sensor 14 according to the embodiment. As illustrated in FIG. 3, the three-dimensional sensor 13 has a detection range 130. The three-dimensional sensor 13 detects three-dimensional data of a detection target disposed in the detection range 130. In the embodiment, the three-dimensional sensor 13 includes a three-dimensional sensor 13F that detects three-dimensional data in front of the vehicle body 7 and a three-dimensional sensor 13B that detects three-dimensional data behind the vehicle body 7. The detection range 130 of the three-dimensional sensor 13 includes a detection range 130F of the three-dimensional sensor 13F and a detection range 130B of the three-dimensional sensor 13B. At least a part of the detection range 130F is defined in front of the excavation working equipment 9. At least a part of the detection range 130B is defined behind the ripper working equipment 10.

As illustrated in FIG. 3, the obstacle sensor 14 has a detection range 140. The obstacle sensor 14 detects an obstacle disposed in the detection range 140. In the embodiment, the obstacle sensor 14 detects an obstacle behind the vehicle body 7. The obstacle sensor 14 includes an obstacle sensor 14L disposed on the left side of the center of the vehicle body 7 in the left-right direction and an obstacle sensor 14R disposed on the right side. The detection range 140 of the obstacle sensor 14 includes a detection range 140L of the obstacle sensor 14L and a detection range 140R of the obstacle sensor 14R. At least a part of the detection range 140L and at least a part of the detection range 140R are defined behind the vehicle body 7. At least a part of the detection range 140L is defined on the left side of the vehicle body 7. At least a part of the detection range 140R is defined on the right side of the vehicle body 7.

### [Operation of Work Machine]

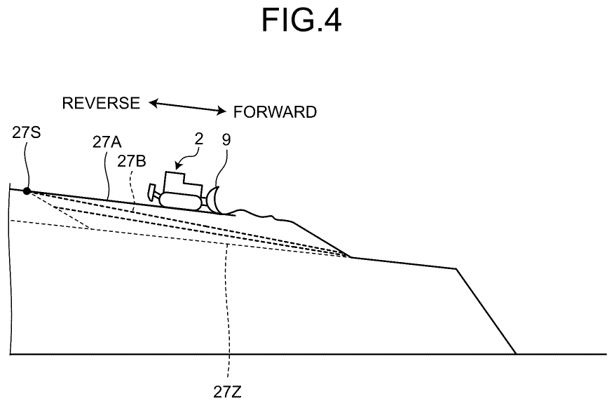

FIG. 4 is a diagram schematically illustrating an example of the operation of the work machine 2 according to the embodiment. In the embodiment, the work machine 2 can perform slot dozing. The slot dozing refers to a construction method in which the work machine 2 excavates the work target while repeating forward movement and reverse movement along a slot-shaped excavation lane formed in the work target. In the embodiment, the work machine 2 performs slot dozing by automatic control. As illustrated in FIG. 4, the work machine 2 performs slot dozing such that the current terrain has a shape along a final design surface 27Z. In the example illustrated in FIG. 4, in the first excavation, the work machine 2 excavates the work target with the excavation working equipment 9 while moving forward from an excavation start point 27S so that the current terrain has a shape along a first intermediate design surface 27A. After the first excavation is completed, the work machine 2 moves in reverse to return to the excavation start point 27S. In the second excavation, the work machine 2 excavates the work target with the excavation working equipment 9 while moving forward from the excavation start point 27S so that the current terrain has a shape along a second intermediate design surface 27B. The work machine 2 repeats forward movement and reverse movement until the current terrain becomes a shape along the final design surface 27Z.

Note that the automatic control of the work machine 2 may be semi-automatic control performed in conjunction with manual operation by an operator, or may be fully automatic control performed without manual operation. In the case of the semi-automatic control, an operation device for manual operation may be mounted on the work machine 2 and may be boarded by an operator riding on the work machine 2. An operation device for manual operation may be disposed outside the work machine 2 and remotely operated by an operator present outside the work machine 2.

### [Detection System]

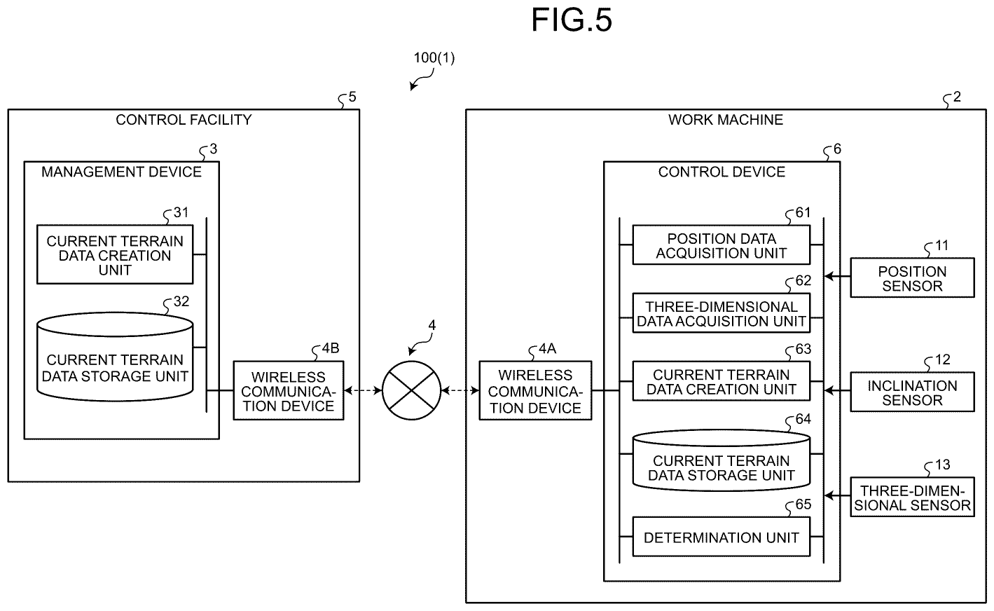

FIG. 5 is a block diagram illustrating a detection system 100 for the work machine 2 according to the embodiment. The management system 1 includes a detection system 100. The detection system 100 detects cliffs present at work sites. The detection system 100 includes the control device 6, the position sensor 11, the inclination sensor 12, and the three-dimensional sensor 13. The control device 6 includes a position data acquisition unit 61, a three-dimensional data acquisition unit 62, a current terrain data creation unit 63, a current terrain data storage unit 64, and a determination unit 65.

The position data acquisition unit 61 acquires position data indicating the current position of the work machine 2. The current position of the work machine 2 includes detection data of the position sensor 11. The position data acquisition unit 61 acquires detection data of the position sensor 11 as position data. The position data acquisition unit 61 acquires posture data indicating the posture of the work machine 2. The posture of the work machine 2 includes detection data of the inclination sensor 12. The position data acquisition unit 61 acquires detection data of the inclination sensor 12 as posture data.

The three-dimensional data acquisition unit 62 acquires three-dimensional data indicating a three-dimensional shape of a work site where the work machine 2 operates. The three-dimensional data of the work site includes detection data of the three-dimensional sensor 13. The three-dimensional data acquisition unit 62 acquires detection data of the three-dimensional sensor 13 as three-dimensional data.

The current terrain data creation unit 63 creates the current terrain data of the work site on the basis of the three-dimensional data acquired by the three-dimensional data acquisition unit 62, the position data indicating the current position of the work machine 2 acquired by the position data acquisition unit 61, and the posture data indicating the posture of the work machine 2 acquired by the position data acquisition unit 61. The current terrain data creation unit 63 creates the current terrain data of the work site on the basis of the detection data of the three-dimensional sensor 13, the detection data of the position sensor 11, and the detection data of the inclination sensor 12.

The current terrain data storage unit 64 stores the current terrain data of the work site created by the current terrain data creation unit 63. The current terrain data storage unit 64 stores the current terrain data and time in association with each other. In addition, the current terrain data storage unit 64 stores the current terrain data, the time, and the current position of the work machine 2 in association with each other on the basis of the position data indicating the current position of the work machine 2 acquired by the position data acquisition unit 61. The time associated with the current terrain data is the time when the three-dimensional sensor 13 detects the detection target or the time when the position data acquisition unit 61 acquires the position data. The current position of the work machine 2 associated with the current terrain data is the current position of the work machine 2 when the three-dimensional sensor 13 detects the detection target or the current position of the work machine 2 when the position data acquisition unit 61 acquires the position data.

The determination unit 65 determines whether or not there is a cliff at the work site on the basis of the storage data stored in the current terrain data storage unit 64.

In a case where the three-dimensional data is acquired by the three-dimensional data acquisition unit 62, the current terrain data storage unit 64 updates the time corresponding to the current terrain data. In a case where the position data is acquired by the position data acquisition unit 61, the current terrain data storage unit 64 updates the time corresponding to the current terrain data. In a case where the three-dimensional data is not acquired by the three-dimensional data acquisition unit 62 or in a case where the position data is not acquired by the position data acquisition unit 61, the current terrain data storage unit 64 does not update the time corresponding to the current terrain data. The determination unit 65 determines that there is a cliff at the work site corresponding to the current terrain data where the non-update period during which the time is not updated exceeds a predetermined period.

The management device 3 includes a current terrain data creation unit 31 and a current terrain data storage unit 32. As described above, there is a plurality of work machines 2 at the work site. Each of the plurality of work machines 2 transmits the current terrain data stored in the current terrain data storage unit 64 to the management device 3 via the communication system 4. The current terrain data creation unit 31 integrates the current terrain data transmitted from each of the plurality of work machines 2 to create the current terrain data of the work site. The current terrain data storage unit 32 stores the current terrain data created by the current terrain data creation unit 31. Each of the plurality of work machines 2 transmits the current terrain data to the management device 3 at predetermined time intervals. Each of the plurality of work machines 2 transmits current terrain data to the management device 3, for example, every second. The current terrain data creation unit 31 creates the current terrain data each time the current terrain data is received. Each time the current terrain data creation unit 31 creates the current terrain data, the current terrain data stored in the current terrain data storage unit 32 is updated.

### [Storage Data]

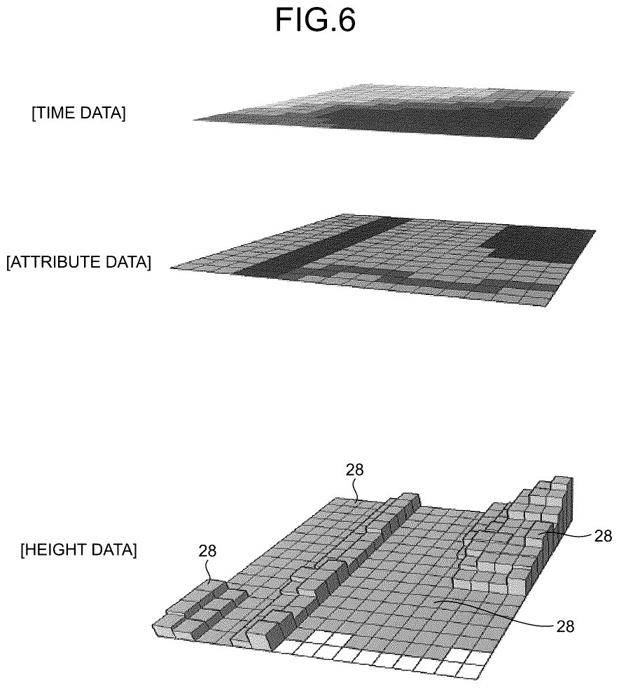

FIG. 6 is a diagram for explaining storage data stored in the current terrain data storage unit 64 according to the embodiment. As illustrated in FIG. 6, the three-dimensional data of the work site includes height data of each of the plurality of detection points 28 defined on the surface of the terrain of the work site. The position of each of the plurality of detection points 28 in the global coordinate system is determined on the basis of the current position of the work machine 2 when the three-dimensional data is acquired, the posture of the work machine 2, and the three-dimensional data. Note that the position of the detection point 28 may be defined in the global coordinate system or may be defined in a predetermined coordinate system such as a local coordinate system set in the work machine 2. Time data indicating time is assigned to each of the plurality of detection points 28. The time indicated by the time data refers to the time when the three-dimensional data acquisition unit 62 acquires the detection point 28 or the time when the position data acquisition unit 61 acquires the position data corresponding to the detection point 28. Note that the time of the time data may be regarded as the time when the three-dimensional sensor 13 detects the detection point 28. The time data is stored in association with each of the plurality of detection points 28. Further, attribute data indicating an attribute is assigned to each of the plurality of detection points 28. The attribute indicated by the attribute data refers to an attribute of the detection point 28. The attribute of the detection point 28 includes an attribute related to the terrain of the work site and an attribute related to an obstacle present at the work site. The attribute data is stored in association with each of the plurality of detection points 28.

The determination unit 65 determines whether or not there is a cliff on the basis of the time when the height data of each of the plurality of detection points 28 is acquired by the three-dimensional data acquisition unit 62 or the time when the position data corresponding to each of the plurality of detection points 28 is acquired by the position data acquisition unit 61.

[Method for Determining Presence or Absence of Cliff]

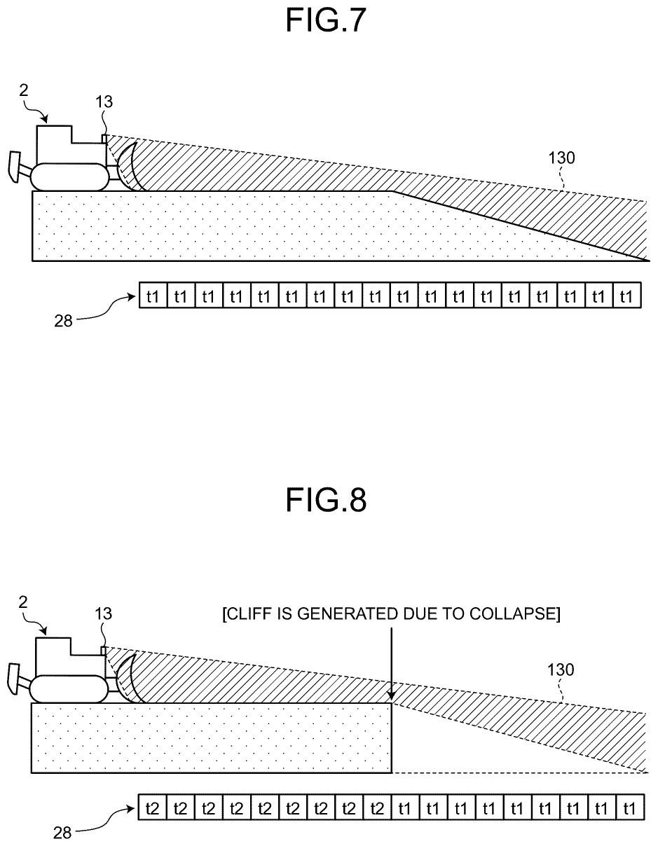

Each of FIGS. 7, 8, 9, and 10 is a diagram for explaining a method for determining whether or not there is a cliff by the determination unit 65 according to the embodiment. In the slot dozing, the work machine 2 excavates the ground while repeating forward movement and reverse movement along the excavation lane. The three-dimensional sensor 13 detects a three-dimensional shape of the ground on which the work machine 2 travels. Time data indicating the time when the detection point 28 is acquired by the three-dimensional data acquisition unit 62 is assigned to the detection point 28. The plurality of detection points 28 disposed in the detection range 130 is simultaneously detected. As illustrated in FIG. 7, in a case where there is no cliff at the work site, the three-dimensional data acquisition unit 62 simultaneously acquires each of the height data of the plurality of detection points 28 disposed in the detection range 130. FIG. 7 illustrates an example in which the three-dimensional data acquisition unit 62 acquires the height data of the detection point 28 at time t1. Time t1 is assigned to each of the plurality of detection points 28 as time data.

For example, a cliff may be generated at a work site due to a collapse. As illustrated in FIG. 8, in a case where a steep descending cliff is generated, the three-dimensional sensor 13 can detect the ground in front of the cliff, but cannot detect the cliff. In a case where the three-dimensional sensor 13 is a laser sensor, the laser light emitted from the three-dimensional sensor 13 is applied to the ground in front of the cliff, but is not applied to the cliff. Therefore, the three-dimensional sensor 13 cannot detect the cliff. The three-dimensional data acquisition unit 62 can acquire the height data of the detection point 28 on the ground in front of the cliff, but cannot acquire the height data of the detection point 28 on the cliff. In a case where the cliff is generated after time t1, the three-dimensional data acquisition unit 62 can acquire the height data of the detection point 28 on the ground in front of the cliff at time t2 after time t1.

The current terrain data storage unit 64 updates the time corresponding to the detection point 28 in a case where the height data of the detection point 28 is acquired by the three-dimensional data acquisition unit 62, and does not update the time corresponding to the detection point 28 in a case where the height data of the detection point 28 is not acquired by the three-dimensional data acquisition unit 62. That is, the current terrain data storage unit 64 updates the time data assigned to the detection point 28 in a case where the height data of the detection point 28 is acquired by the three-dimensional data acquisition unit 62, and does not update the time data assigned to the detection point 28 in a case where the height data of the detection point 28 is not acquired by the three-dimensional data acquisition unit 62. In the example illustrated in FIGS. 7 and 8, the height data of the detection point 28 on the ground in front of the cliff is acquired by the three-dimensional data acquisition unit 62. The height data of the detection point 28 of the cliff is not acquired by the three-dimensional data acquisition unit 62. The current terrain data storage unit 64 updates the time data assigned to the detection points 28 on the ground in front of the cliff where the height data is acquired by the three-dimensional data acquisition unit 62 from time t1 to time t2. The current terrain data storage unit 64 does not update the time data assigned to the detection point 28 of the cliff where the height data is not acquired by the three-dimensional data acquisition unit 62 from time t1.

That is, in the embodiment, the time data of the detection point 28 at which the three-dimensional sensor 13 can detect the height data is updated to the latest time. The time data of the detection point 28 at which the three-dimensional sensor 13 cannot detect the height data is not updated and is maintained at the past time.

The determination unit 65 determines that there is a cliff at the work site corresponding to the detection point 28 where the non-update period during which the time is not updated exceeds a predetermined period. In the slot dozing, the three-dimensional shape of the same area of the work site is detected a plurality of times by the three-dimensional sensor 13. The three-dimensional sensor 13 cannot permanently detect the cliff, and the three-dimensional data acquisition unit 62 cannot permanently acquire the height data of the detection point 28 of the cliff. Therefore, the time data of the detection point 28 of the cliff is not permanently updated. The determination unit 65 can determine that there is a cliff at the position of the work site corresponding to the detection point 28 at which the time data is not permanently updated. The determination unit 65 compares the time data of the first detection point 28 with the time data of the second detection point 28 adjacent to the first detection point 28. In a case of determining that the time data of the first detection point 28 is older than the time data of the second detection point 28 by a predetermined period, the determination unit 65 may determine that there is a cliff at the work site corresponding to the first detection point 28.

Furthermore, the determination unit 65 can specify the position of the cliff on the basis of the detection point 28 at which the non-update period does not exceed the predetermined period and the detection point 28 at which the non-update period exceeds the predetermined period. In the example illustrated in FIG. 8, the determination unit 65 can determine that there is a cliff at the boundary between the detection point 28 at which the time data is updated at time t2 and the detection point 28 at which the time data is not updated at time t1.

Note that, in a case where the cliff at the work site is an ascending cliff or a gentle descending cliff, the three-dimensional sensor 13 can detect the cliff. The determination unit 65 can determine whether or not there is a cliff on the basis of the slope of the terrain of the work site calculated from the plurality of detection points.

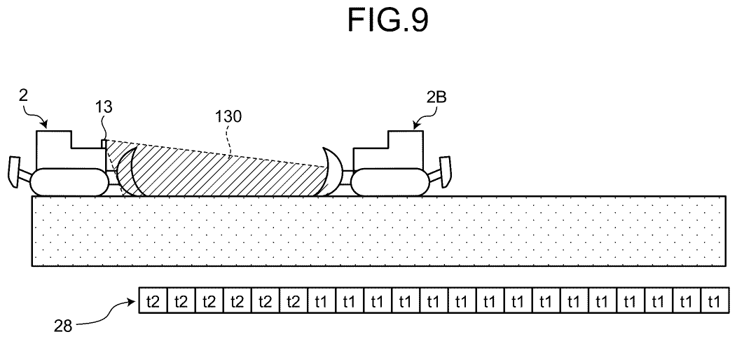

As illustrated in FIG. 9, in a case where there is another work machine 2B as an obstacle in front of the work machine 2, the three-dimensional sensor 13 cannot detect the ground behind the other work machine 2B. The three-dimensional data acquisition unit 62 can acquire the height data of the detection point 28 on the ground in front of the other work machine 2B, but cannot acquire the height data of the detection point 28 on the ground behind the other work machine 2B. The time data assigned to the detection point 28 on the ground in front of the other work machine 2B is updated from time t1 to time t2, but the time data assigned to the detection point 28 on the ground behind the other work machine 2B is maintained at time t1.

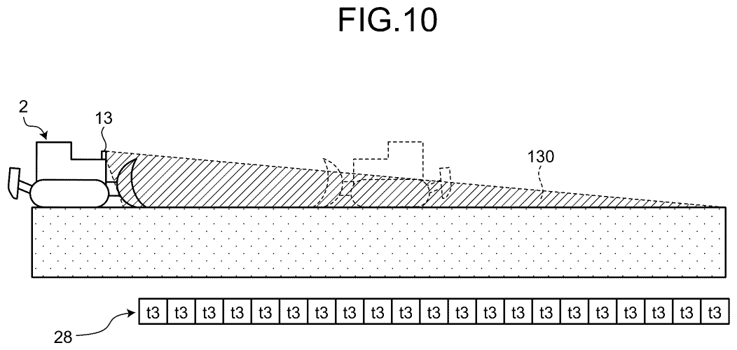

The other work machine 2B is a movable mobile body. As illustrated in FIG. 10, in a case where the other work machine 2B moves away from the front of the work machine 2, the three-dimensional sensor 13 can detect the ground. In a case where the three-dimensional sensor 13 detects the ground at time t3 after the other work machine 2B has moved away, the time data of the detection point 28 to which time t2 has been assigned in FIG. 9 is updated from time t2 to time t3. The time data of the detection point 28 to which time t1 has been assigned in FIG. 9 is updated from time t1 to time t3. The determination unit 65 can determine that there is no cliff at the position of the work site corresponding to the detection point 28 at which the non-update period is equal to or less than the predetermined period.

### [Detection Method]

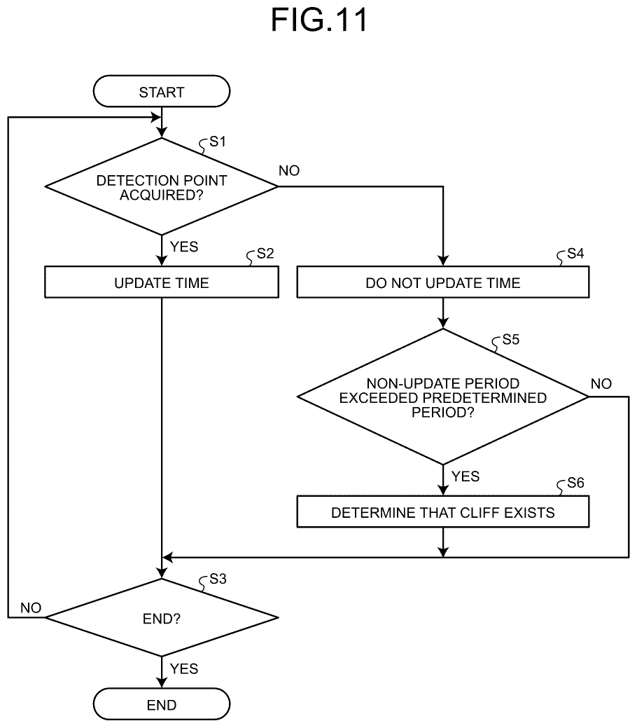

FIG. 11 is a flowchart illustrating a detection method for a work site according to the embodiment. The determination unit 65 determines whether or not the three-dimensional data acquisition unit 62 has acquired the height data of a certain detection point 28 (step S1). In a case where it is determined in step S1 that the three-dimensional data acquisition unit 62 has acquired the height data of the detection point 28 (step S1: Yes), the current terrain data storage unit 64 updates the time of the detection point at which the height data has been acquired (step S2). In step S1, in a case where it is determined that the three-dimensional data acquisition unit 62 cannot acquire the height data of the detection point 28 (step S1: No), the current terrain data storage unit 64 does not update the time of the detection point 28 for which the height data cannot be acquired (step S4). The determination unit 65 determines whether or not the non-update period of the time of the detection point 28 whose time has not been updated exceeds a predetermined period (step S5). In a case where it is determined in step S5 that the non-update period of the time of the detection point 28 exceeds the predetermined period (step S5: Yes), the determination unit 65 determines that there is a cliff at the position corresponding to the detection point 28 (step S6). In a case where it is determined that the non-update period of the time of the detection point 28 does not exceed the predetermined period (Step S5: No), the determination unit 65 determines that there is no cliff at the position corresponding to the detection point 28. After the process of any one of steps S2, S5, and S6 ends, it is determined whether or not to end the cliff detection process (step S3). In a case where it is determined in step S3 that the cliff detection process is not to be ended (step S3: No), the process returns to step S1, and the processes of steps S1 to S6 are executed for another detection point 28. In a case where it is determined in step S3 that the cliff detection process is to be ended (step S3: Yes), the cliff detection process is ended.

### [Computer System]

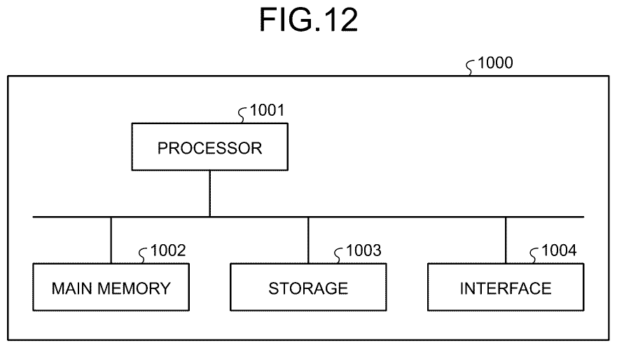

FIG. 12 is a block diagram illustrating a computer system 1000 according to the embodiment. Each of the management device 3 and the control device 6 described above includes the computer system 1000. The computer system 1000 includes a processor 1001 such as a central processing unit (CPU), a main memory 1002 including a non-volatile memory such as a read only memory (ROM) and a volatile memory such as a random access memory (RAM), a storage 1003, and an interface 1004 including an input/output circuit. The functions of the management device 3 and the control device 6 described above are stored in the storage 1003 as computer programs. The processor 1001 reads the computer program from the storage 1003, develops the computer program in the main memory 1002, and executes the above-described processing according to the program. Note that the computer program may be distributed to the computer system 1000 via a network.

According to the above-described embodiment, the computer system 1000 or the computer program can execute: acquiring three-dimensional data of a work site where the work machine 2 operates; storing current terrain data created on the basis of the three-dimensional data and time in association with each other; and determining whether or not there is a cliff at the work site on the basis of storage data stored.

### [Effects]

As described above, the detection system 100 for a work site according to the embodiment includes: the three-dimensional data acquisition unit 62 that acquires three-dimensional data of the work site where the work machine 2 operates; the current terrain data storage unit 64 that stores current terrain data created on the basis of the three-dimensional data and time in association with each other; and the determination unit 65 that determines whether or not there is a cliff at the work site on the basis of the storage data stored in the current terrain data storage unit 64. The three-dimensional data includes height data of each of the plurality of detection points 28. The determination unit 65 can determine whether or not there is a cliff on the basis of the time when the height data of each of the plurality of detection points 28 is acquired. Since the presence of the cliff can be recognized, a decrease in productivity at the work site is suppressed.

### OTHER EMBODIMENTS

In the above-described embodiment, the current terrain data creation unit 63 may create the current terrain data of the work site on the basis of at least the three-dimensional data acquired by the three-dimensional data acquisition unit 62. In addition, the current terrain data creation unit 63 may create the current terrain data of the work site on the basis of at least the position data indicating the current position of the work machine 2 acquired by the position data acquisition unit 61.

In the above-described embodiment, at least a part of the functions of the control device 6 may be provided in the management device 3. At least a part of the functions of the management device 3 may be provided in the control device 6.

In the above-described embodiment, for example, each of the position data acquisition unit 61, the three-dimensional data acquisition unit 62, the current terrain data creation unit 63, the current terrain data storage unit 64, and the determination unit 65 may be configured by different hardware.

In the above-described embodiment, the work machine 2 is a bulldozer. The work machine 2 may be another work machine such as an excavator, a wheel loader, or a motor grader.

### REFERENCE SIGNS LIST

1 MANAGEMENT SYSTEM
2 WORK MACHINE
3 MANAGEMENT DEVICE
4 COMMUNICATION SYSTEM
4A WIRELESS COMMUNICATION DEVICE
4B WIRELESS COMMUNICATION DEVICE
5 CONTROL FACILITY
6 CONTROL DEVICE
7 VEHICLE BODY
8 TRAVELING DEVICE
9 EXCAVATION WORKING EQUIPMENT
10 RIPPER WORKING EQUIPMENT
11 POSITION SENSOR
12 INCLINATION SENSOR
13 THREE-DIMENSIONAL SENSOR
13F THREE-DIMENSIONAL SENSOR
13B THREE-DIMENSIONAL SENSOR
14 OBSTACLE SENSOR
14L OBSTACLE SENSOR
14R OBSTACLE SENSOR
15 ENGINE COMPARTMENT
16 ENGINE
17 CRAWLER BELT
18 EXCAVATION BLADE
18A CUTTING EDGE
19 LIFT FRAME
20 TILTING CYLINDER
21 LIFT CYLINDER
22 SHANK
22A RIPPER POINT
23 RIPPER ARM
24 TILTING CYLINDER
25 LIFT CYLINDER
26 BEAM
27A FIRST INTERMEDIATE DESIGN SURFACE
27B SECOND INTERMEDIATE DESIGN SURFACE
27S EXCAVATION START POINT
27Z FINAL DESIGN SURFACE
28 DETECTION POINT
31 CURRENT TERRAIN DATA CREATION UNIT
32 CURRENT TERRAIN DATA STORAGE UNIT
61 POSITION DATA ACQUISITION UNIT
62 THREE-DIMENSIONAL DATA ACQUISITION UNIT
63 CURRENT TERRAIN DATA CREATION UNIT
64 CURRENT TERRAIN DATA STORAGE UNIT
65 DETERMINATION UNIT
100 DETECTION SYSTEM
130 DETECTION RANGE
130F DETECTION RANGE
130B DETECTION RANGE
140 DETECTION RANGE
140L DETECTION RANGE
140R DETECTION RANGE
1000 COMPUTER SYSTEM
1001 PROCESSOR
1002 MAIN MEMORY
1003 STORAGE
1004 INTERFACE

1. A detection system for a work site, the detection system comprising:
a three-dimensional data acquisition unit that acquires three-dimensional data of the work site where a work machine operates;
a current terrain data storage unit that stores current terrain data created on a basis of the three-dimensional data and time in association with each other; and
a determination unit that determines whether or not there is a cliff at the work site on a basis of storage data stored in the current terrain data storage unit.

2. The detection system for the work site according to claim 1,
wherein the current terrain data storage unit updates the time in a case where the three-dimensional data is acquired by the three-dimensional data acquisition unit, and does not update the time in a case where the three-dimensional data is not acquired by the three-dimensional data acquisition unit, and
the determination unit determines that there is a cliff at the work site corresponding to the current terrain data where a non-update period during which the time is not updated exceeds a predetermined period.

3. The detection system for the work site according to claim 1,
wherein the current terrain data includes height data of each of a plurality of detection points defined on a surface of a terrain of the work site, and
the determination unit determines whether or not there is a cliff on a basis of the time when the height data of each of the plurality of detection points is acquired.

4. The detection system for the work site according to claim 3,
wherein the current terrain data storage unit updates the time corresponding to the detection point in a case where the height data of the detection point is acquired by the three-dimensional data acquisition unit, and does not update the time corresponding to the detection point in a case where the height data of the detection point is not acquired by the three-dimensional data acquisition unit, and
the determination unit determines that there is a cliff at the work site corresponding to the detection point where a non-update period during which the time is not updated exceeds a predetermined period.

5. The detection system for the work site according to claim 4,
wherein the determination unit specifies a position of a cliff on a basis of the detection point at which the non-update period does not exceed a predetermined period and the detection point at which the non-update period exceeds a predetermined period.

6. The detection system for the work site according to claim 3,
wherein the determination unit determines whether or not there is a cliff on a basis of a slope of the terrain of the work site calculated from the plurality of detection points.

7. The detection system for the work site according to claim 1,
wherein the work machine includes a three-dimensional sensor that detects a three-dimensional shape of the work site, and
the three-dimensional data acquisition unit acquires detection data of the three-dimensional sensor as the three-dimensional data.

8. The detection system for the work site according to claim 1, further comprising
a position data acquisition unit that acquires position data indicating a current position of the work machine,
wherein the current terrain data storage unit stores the current terrain data, the time, and the current position in association with each other.

9. A detection method for a work site, the detection method comprising:
acquiring three-dimensional data of the work site where a work machine operates;
storing current terrain data created on a basis of the three-dimensional data and time in association with each other; and
determining whether or not there is a cliff at the work site on a basis of storage data stored.
